(19) United States
(12) Patent Application Publication
(10) Pub. No.: US 2026/0027568 A1
(43) Pub. Date: Jan. 29, 2026

(54) TOOL STRUCTURE OF RECYCLING MECHANISM

(71) Applicant: Reverse Energy Solutions Corp., Chicago, IL (US)

(72) Inventors: Hsiao-Feng TU, New Taipei (TW); Wen-Chieh LIAO, Taipei (TW)

(21) Appl. No.: 18/905,315

(22) Filed: Oct. 3, 2024

(30) Foreign Application Priority Data
Jul. 29, 2024 (TW) 113128107

(51) Int. Cl. B02C 18/18; B02C 18/00; B02C 18/14; B09B 3/35; B09B 101/50

(52) U.S. Cl. CPC B02C 18/18; B02C 18/0084; B02C 18/142; B09B 3/35; B09B 2101/50

(57) ABSTRACT

The present invention relates to a tool structure of recycling mechanism, which includes a shaft part having two mounting shaft rods respectively located on two opposite ends thereof for assembly on a preset frame rack, and a wheel cutter part disposed on the shaft part and having a plurality of toothed cutters respectively formed in the shape of a trapezoidal tooth, a saw tooth, a blade or a conical tooth on the outer circumference of a rotating wheel. The tool structure can be used in a recycling mechanism to crush and destroy glass panels on the surfaces of the waste materials to be recycled.

This application claims the priority benefit of Taiwan patent application number 113128107, filed on Jul. 29, 2024.

### BACKGROUND OF THE INVENTION

### 1. Field of the Invention

The present invention provides a tool structure of recycling mechanism that can be used for pressed, rolling and recycling waste materials, in particular a tool structure, which has a rotating wheel of a wheel cutter part installed on at least one shaft part, and a plurality of toothed cutters formed on the outer circumference of the rotating wheel for performing pressing and breaking operations on the glass panels on the surfaces of the preset waste materials, so as to achieve the purpose of processing and treating the recycled waste materials.

### 2. Description of the Related Art

As domestic electricity consumption continues to increase and power supply becomes very tight, many companies, factories, or homes will install solar panels to store electricity to provide part of the required electricity. The solar power generation collects heat energy from sunlight through solar panels and converts it into electrical energy to meet various power needs. The solar panels generally used are composed mainly of a solar cell module sandwiched between two layers of ethylene vinyl acetate (EVA), and then encapsulated with a glass panel and an insulating backplane to form a layered composite structure. However, the solar panels are usually installed on a certain scale and the number of solar panels used is also considerable. However, the solar panels have a certain lifespan. When they can no longer be used, they must be discarded and new solar panels must be installed to generate electricity. As for discarded solar panels, they need to be recycled and processed to avoid pollution or damage to the environment.

Currently, the recycling of discarded solar panels mostly adopts methods such as thermal cracking, hot knife, chemical treatment, laser or incineration, etc. Usually, the frame of the solar panel is dismantled first, the glass on the solar panel is crushed, and the electronic products are recycled. Then, different waste materials such as glass, metal or plastic are broken into small pieces by mechanical crushing before further processing. However, the solar panels are large in size and heavy in weight, and both assembly and disassembly are time-consuming and labor-intensive. After they are discarded, the processing of various types of discarded solar panels must be carried out separately and in batches. The handling, transfer, stacking or storage of waste materials during the process also causes considerable trouble and is likely to cause harm to the safety of workers. Not only does it require a large amount of manpower to carry out the processing operations, but it also requires larger and more space for various processing operations to be implemented and executed. The waste materials treatment process is extremely time-consuming and labor-intensive, and is not economical. There are many deficiencies that need to be improved.

### SUMMARY OF THE INVENTION

Therefore, in view of the above problems and deficiencies, the inventor collected relevant information, evaluated and considered various aspects, and used his many years of experience in this industry to continuously create, research and improve, and finally designed the invention patent of this tool structure of recycling mechanism.

The main object of the present invention is that the tool structure of recycling mechanism includes at least one shaft part having two mounting shaft rods respectively located on two opposite ends thereof for assembly on a preset frame rack, and a wheel cutter part disposed on the at least one shaft part and having a plurality of toothed cutters respectively formed in the shape of a trapezoidal tooth, a saw tooth, a blade tooth or a conical tooth on the outer circumference of a rotating wheel installed at the mounting shaft rod. The tool structure can be used in a recycling mechanism to crush and destroy glass panels on the surfaces of the waste materials to be recycled.

Another object of the present invention is that the diameter of the at least one shaft part can be 210 mm to 260 mm, and the preferred diameter of the at least one shaft part can be 240 mm, and its length (C1) can be 700 mm to 800 mm, and the preferred length (C1) can be 754 mm.

Still another object of the present invention is that the at least one shaft part is provided with two mounting shaft rods with a reduced outer diameter respectively located on two opposite ends thereof; and the plurality of rotating wheels are integrally formed at the at least one shaft part, and the plurality of toothed cutters are provided on the outer circumference of each rotating wheel; the diameter of each rotating wheel of the wheel cutter part can be 145 mm to 185 mm, and the preferred diameter of each rotating wheel can be 165 mm, and the distance between any two adjacent toothed cutters can be 3.01 mm; each rotating wheel has 94 toothed cutters provided on the outer circumference thereof, and each toothed cutter is selectively in the shape of a trapezoidal tooth, a saw tooth, a blade tooth or a conical tooth, etc.; the trapezoidal angle (θ1) of each toothed cutter ranges from 35° to 40°, and the preferred trapezoidal angle (θ1) of each toothed cutter can be 37.23°, and the included angle (θ2) between each two adjacent toothed cutters may be 30° to 36°, and the preferred included angle (θ2) may be 33.4°.

Still another object of the present invention is that the at least one shaft part is provided with two mounting shaft rods with a reduced outer diameter respectively located on two opposite ends thereof; and the plurality of rotating wheels of the same thickness or different thickness are integrally formed at the at least one shaft part, and the plurality of toothed cutters are provided on the outer circumference of each rotating wheel; the diameter of each rotating wheel of the wheel cutter part can be 145 mm to 185 mm, and the preferred diameter of each rotating wheel can be 165 mm, and its thickness (C2) can be 75 mm to 85 mm, and the preferred thickness (C2) can be 81 mm; each rotating wheel has 83 toothed cutters provided on the outer circumference thereof, and each toothed cutter is selectively in the shape of a trapezoidal tooth, a saw tooth, a blade tooth or a conical tooth; each toothed cutter in the shape of a trapezoidal tooth has a bottom width of 6 mm, a top width of 3 mm and a height of 5 mm; the distance between each two adjacent toothed cutters is 3.08 mm, the trapezoidal angle (θ3) of each toothed cutter ranges from 35° to 40°, and the preferred trapezoidal angle (θ3) of each toothed cutter is 37.74°; and the included angle (θ4) between each two adjacent toothed cutters ranges from 30° to 36°, the preferred included angle (θ4) between each two adjacent toothed cutters is 33.4°.

### BRIEF DESCRIPTION OF THE DRAWINGS

FIG. 1 is a three-dimensional external view of the recycling mechanism of the present invention.

FIG. 2 is a side view of the recycling mechanism of the present invention.

FIG. 3 is a top view of the recycling mechanism of the present invention.

FIG. 4 is a radial side view of the tool structure of the first embodiment of the present invention.

FIG. 5 is an axial side view of the tool structure of the first embodiment of the present invention.

FIG. 6 is a radial side view of the tool structure of the second embodiment of the present invention.

FIG. 7 is an axial side view of the tool structure of the second embodiment of the present invention.

### DETAILED DESCRIPTION OF THE INVENTION

In order to achieve the above-mentioned objects and effect, the technical means and structure, implementation method, etc. adopted by the present invention are described in detail with reference to the preferred embodiment of the present invention, and its features and functions are as follows, so as to facilitate a complete understanding.

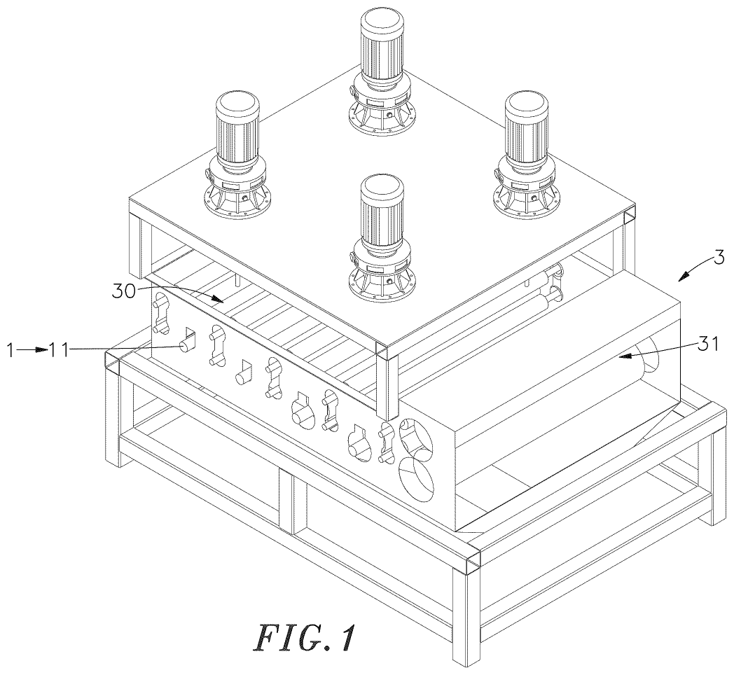

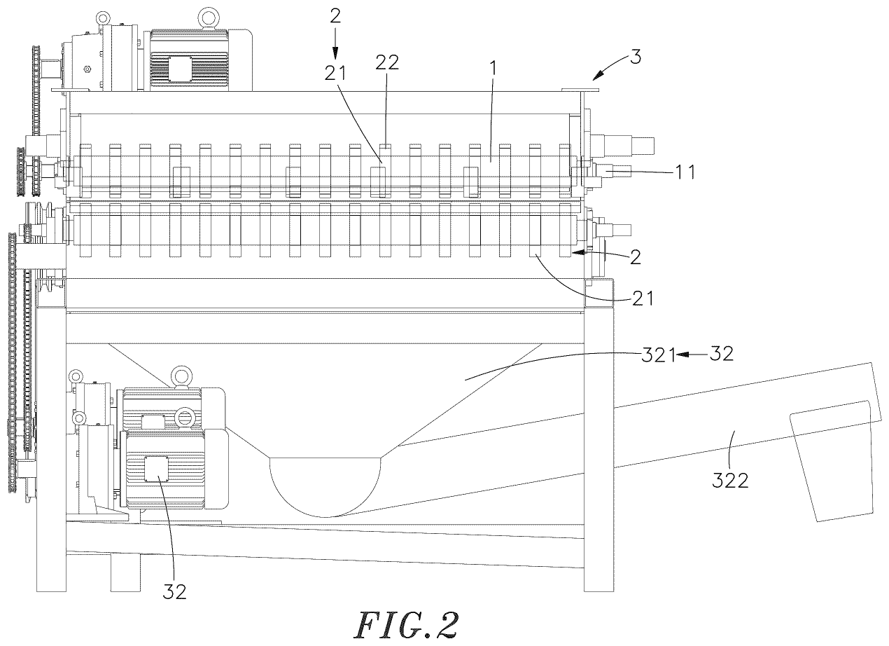

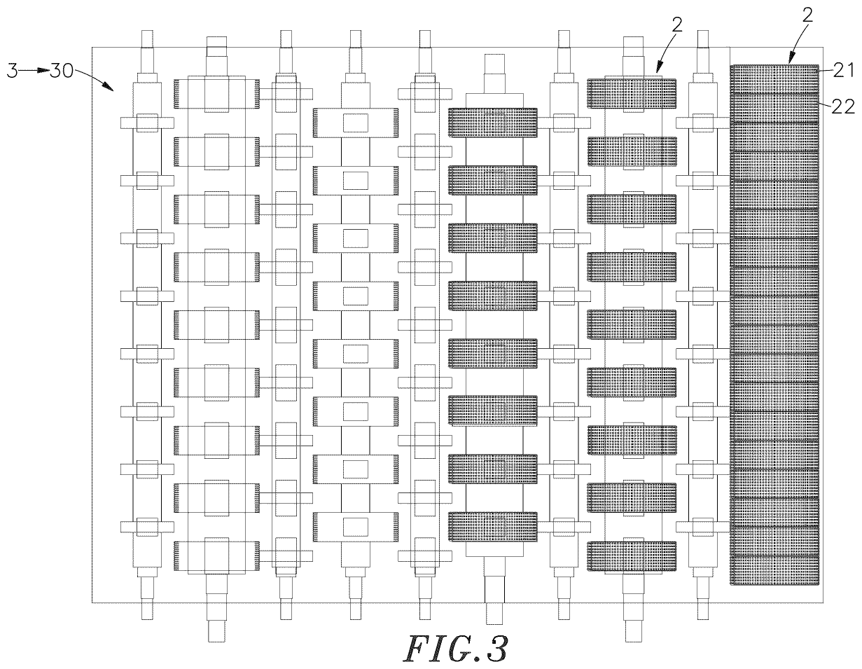

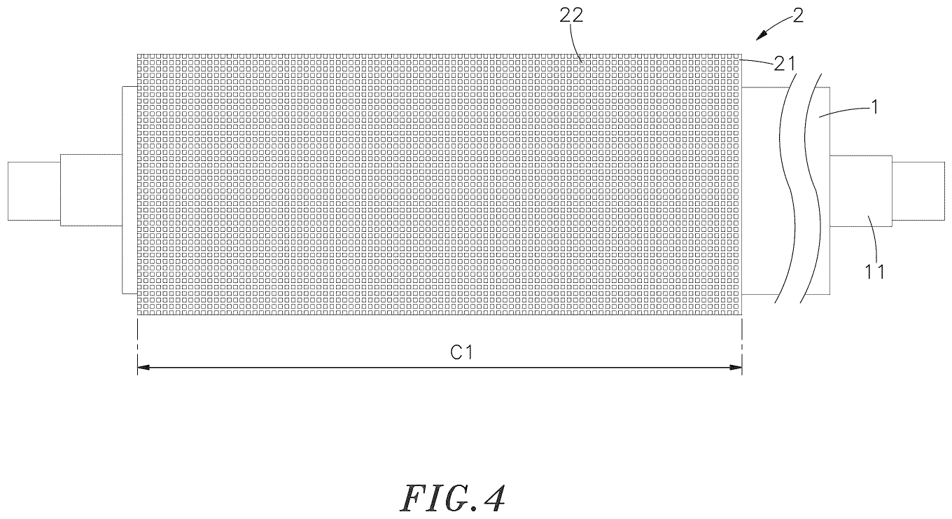

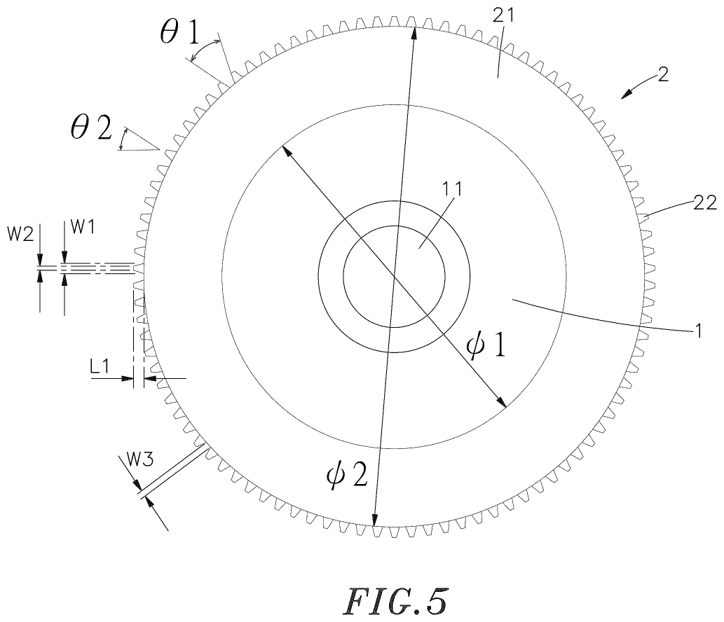

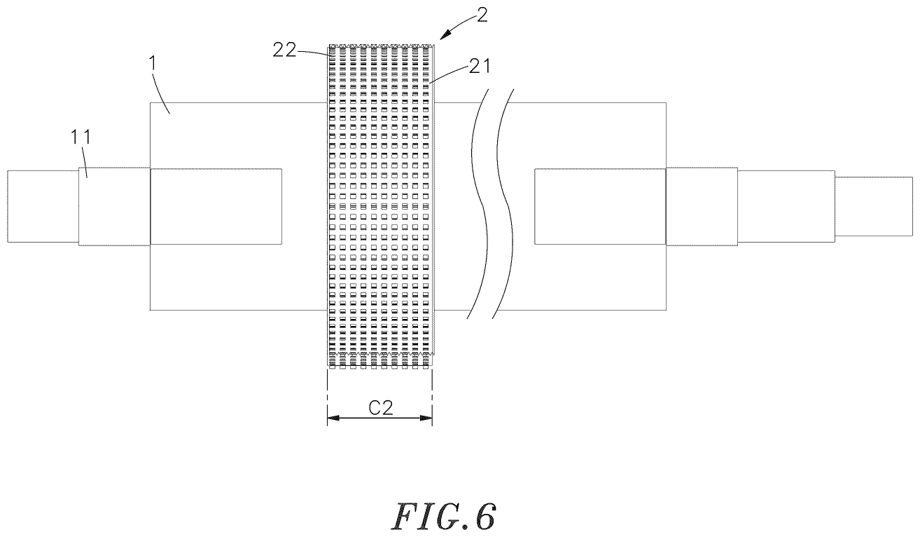

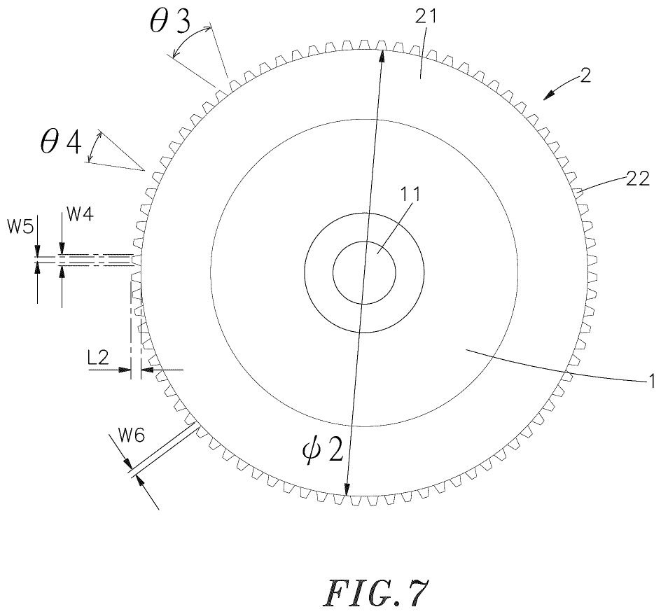

Please refer to FIGS. 1 to 7. The present invention comprises at least one shaft part 1 and a wheel cutter part 2.

The at least one shaft part 1 comprises two mounting shaft rods 11 respectively located on two opposite ends thereof, and can be assembled on a preset frame rack 3 by using the mounting shaft rods 11.

The wheel cutter part 2 comprises a rotating wheel 21 and a plurality of toothed cutters 22 formed on the outer circumference of the rotating wheel 21. The rotating wheel 21 is disposed at the mounting shaft rods 11 of the at least one shaft part 1.

The diameter (ψ1) of the above-mentioned at least one shaft part 1 of the present invention may be 210 mm to 260 mm, and the preferred diameter (ψ1) of the at least one shaft part 1 may be 240 mm, and the length (C1) of the at least one shaft part 1 may be 700 mm to 800 mm, and the preferred length (C1) thereof may be 754 mm.

Furthermore, the above-mentioned at least one shaft part 1 of the present invention is provided with the mounting shaft rods 11 with a reduced outer diameter on both sides. The rotating wheel 21 of the wheel cutter part 2 is integrally formed at the at least one shaft part 1, and the plurality of toothed cutters 22 are provided at the outer circumference of the rotating wheel 21. The diameter (2) of the rotating wheel 21 of the wheel cutter part 2 may be 145 mm to 185 mm, and the preferred diameter (ψ2) of the rotating wheel 21 may be 165 mm, and the thickness (C2) thereof may be 75 mm to 85 mm, and the preferred thickness (C2) thereof may be 81 mm. In addition, 94 toothed cutters 22 may be integrally formed on the outer circumference of the rotating wheel 21. Each toothed cutter 22 may be in the shape of a trapezoidal tooth, a saw tooth, a blade, or a conical tooth, etc. The bottom width (W1) of each toothed cutter 22 in the shape of a trapezoidal tooth can be 5 mm, the top width (W2) thereof can be 2 mm, the height (L1) thereof can be 5 mm, and the distance (W3) between any two adjacent toothed cutters 22 can be 3.01 mm. Furthermore, the trapezoidal angle (θ1) of each toothed cutter 22 can be 35° to 40°, and the preferred trapezoidal angle (θ1) of each toothed cutter 22 can be 37.23°, wherein the included angle (θ2) between any two adjacent toothed cutters 22 can be 30° to 36°, and the preferred included angle (θ2) thereof can be 33.4°.

Furthermore, the above-mentioned at least one shaft part 1 of the present invention may be provided with mounting shaft rods 11 with reduced outer diameters on both sides, and at least one rotating wheel 21 of the wheel cutter part 2 may be assembled at the at least one shaft part 1, and the plurality of toothed cutters 22 is provided on the outer circumference of the rotating wheel 21. The at least one wheel cutter part 2 includes a plurality of rotating wheels 21 of the same thickness or different thickness, and the diameter of the rotating wheels 21 of the wheel cutter part 2 can be 145 mm to 185 mm, and the preferred diameter of the rotating wheels 21 can be 165 mm, and 83 toothed cutters 22 may be formed on the outer circumference of each rotating wheel 21. Each toothed cutter 22 may be in the shape of a trapezoidal tooth, a saw tooth, a blade, or a conical tooth, etc. The bottom width (W4) of each toothed cutter 22 in the shape of a trapezoidal tooth can be 6 mm, the top width (W5) thereof can be 3 mm, the height (L2) thereof can be 5 mm, and the distance (W6) between any two adjacent toothed cutters 22 can be 3.08 mm. Furthermore, the trapezoidal angle (θ3) of each toothed cutter 22 can be 35° to 40°, and the preferred trapezoidal angle (θ3) of each toothed cutter 22 can be 37.74°, wherein the included angle (θ4) between any two adjacent toothed cutters 22 can be 30° to 36°, and the preferred included angle (θ4) thereof can be 33.4°. The preferred length (C1) of the at least one shaft part 1 can be 754 mm, and 9 or 41 rotating wheels 21 can be preferably assembled to form the preferred length (C1) (the used number of rotating wheels 21 can be adjusted to increase or decrease according to actual application conditions, and can be adjusted to match the diameter size of each rotating wheel 21).

When the tool structure of recycling mechanism of the present invention is implemented, the preset waste materials (which may be discarded or faulty solar panels to be recycled and waiting for processing) can be transported to a working space 30 through a feed inlet 31 of the preset frame rack 3. Then, the at least one shaft part 1 in the working space 30 can drive the rotating wheel 21 of the wheel cutter part 2 to rotate at a predetermined speed (the speed of the wheel cutter part 2 needs to be adjusted faster or slower depending on the application conditions, but it is not the focus of the present invention, so the speed adjustment method will not be described in detail). Then the preset waste materials can be pressed by the plurality of toothed cutters 22 on the outer circumference of the rotating wheel 21 to press, push and break the glass panels covering the surfaces of the preset waste materials, so that the glass panels on the surfaces of the preset waste materials are pressed and broken into glass fragments. The glass fragments then fall down into a collection part 321 of a recycling area 32 along the gap between the shaft part 1 and the wheel cutter part 2, and then are sent out through a conveyor belt 322 for subsequent processing.

The above is merely a preferred embodiment of the present invention and is not intended to limit the patent scope of the present invention. Therefore, all simple modifications and equivalent structural changes made by using the contents of the description and drawings of the present invention should be included in the patent scope of the present invention and should be declared.

In summary, the tool structure of recycling mechanism of the present invention can truly achieve its effect and purpose when it is actually applied. Therefore, this invention is truly a research and development creation with excellent practicality. In order to meet the application requirements for invention patents, an application is filed in accordance with the law. I hope that the review committee will approve this case as soon as possible to protect the inventor's hard work in research and development. If the review committee has any questions, please feel free to write to us for instructions. The inventor will do his best to cooperate and will be very grateful.

What is claimed is:

1. A tool structure of recycling mechanism, comprising:
at least one shaft part and a wheel cutter part disposed on said at least one shaft part, wherein:
said at least one shaft part comprises two mounting shaft rods respectively located on two opposite ends thereof for assembly on a preset frame rack;
said wheel cutter part comprises at least one rotating wheel and a plurality of toothed cutters formed on the outer circumference of each said rotating wheel.

2. The tool structure of recycling mechanism as claimed in claim 1, wherein a diameter (ψ1) of said at least one shaft part is 210 mm to 260 mm, and the preferred diameter (ψ1) of said at least one shaft part is 240 mm.

3. The tool structure of recycling mechanism as claimed in claim 1, wherein said at least one shaft part is provided with two said mounting shaft rods with a reduced outer diameter respectively located on two opposite ends thereof; at least one said rotating wheel of said wheel cutter part is integrally formed at said at least one shaft part, and the plurality of said toothed cutters are provided on the outer circumference of each said rotating wheel, and a length (C1) of said at least one shaft part is 700 mm to 800 mm, and the preferred length (C1) of said at least one shaft part is 754 mm.

4. The tool structure of recycling mechanism as claimed in claim 3, wherein a diameter (2) of at least one said rotating wheel of said wheel cutter part is 145 mm to 185 mm, and the preferred diameter (ψ2) of at least one said rotating wheel is 165 mm; each said rotating wheel has 94 said toothed cutters provided on the outer circumference thereof, and each said toothed cutter is selectively in the shape of a trapezoidal tooth, a saw tooth, a blade or a conical tooth.

5. The tool structure of recycling mechanism as claimed in claim 4, wherein each said toothed cutter in the shape of a trapezoidal tooth has a bottom width (W1) of 5 mm, a top width (W2) of 2 mm and a height (L1) of 5 mm; a distance (W3) between each two adjacent said toothed cutters is 3.01 mm, a trapezoidal angle (θ1) of each said toothed cutter ranges from 35° to 40°, the preferred trapezoidal angle (θ1) of each said toothed cutter is 37.23°; and the included angle (θ2) between each two adjacent said toothed cutters is ranges from 30° to 36°, the preferred included angle (θ2) between each two adjacent said toothed cutters is 33.4°.

6. The tool structure of recycling mechanism as claimed in claim 1, wherein said at least one shaft part is provided with two said mounting shaft rods with a reduced outer diameter respectively located on two opposite ends thereof; the plurality of said rotating wheels are integrally formed at said at least one shaft part, and said rotating wheels have the same thickness, and the plurality of said toothed cutters are provided on the outer circumference of each said rotating wheel.

7. The tool structure of recycling mechanism as claimed in claim 1, wherein said at least one shaft part is provided with two said mounting shaft rods with a reduced outer diameter respectively located on two opposite ends thereof; the plurality of said rotating wheels are integrally formed at said at least one shaft part, and said rotating wheels have different thickness, and the plurality said of toothed cutters are provided on the outer circumference of each said rotating wheel.

8. The tool structure of recycling mechanism as claimed in claim 1, wherein a diameter (ψ2) of at least one said rotating wheel of said wheel cutter part is 145 mm to 185 mm, and the preferred diameter (ψ2) of at least one said rotating wheel is 165 mm; and a thickness (C2) thereof is 75 mm to 85 mm, and the preferred thickness (C2) thereof is 81 mm; each said rotating wheel has 83 said toothed cutters provided on the outer circumference thereof, and each said toothed cutter is selectively in the shape of a trapezoidal tooth, a saw tooth, a blade or a conical tooth.

9. The tool structure of recycling mechanism as claimed in claim 8, wherein each said toothed cutter in the shape of a trapezoidal tooth has a bottom width (W4) of 6 mm, a top width (W5) of 3 mm and a height (L2) of 5 mm; the distance (W6) between each two adjacent said toothed cutters is 3.08 mm, the trapezoidal angle (θ3) of each said toothed cutter ranges from 35° to 40°, the preferred trapezoidal angle (θ3) of each said toothed cutter is 37.74°; and the included angle (θ4) between each two adjacent said toothed cutters ranges from 30° to 36°, the preferred included angle (θ4) between each two adjacent said toothed cutters is 33.4°.
